(19) United States
(12) Patent Application Publication
(10) Pub. No.: US 2019/0281533 A1
(43) Pub. Date: Sep. 12, 2019

(54) WIRELESS TERMINAL DEVICE AND COMMUNICATIONS METHOD

(71) Applicant: NTT DOCOMO, INC., Tokyo (JP)

(72) Inventors: Shinpei Yasukawa, Tokyo (JP); Satoshi Nagata, Tokyo (JP); Riichi Kudou, Chiyoda-Ku, Tokyo (JP); Tatsunori Obara, Tokyo (JP)

(73) Assignee: NTT DOCOMO, INC., Tokyo (JP)

(21) Appl. No.: 16/346,194

(22) PCT Filed: Oct. 30, 2017
(86) PCT No.: PCT/JP2017/039154

§ 371 Date: Apr. 30, 2019

(30) Foreign Application Priority Data
Nov. 1, 2016 (JP) 2016-214692

(51) Int. Cl. H04W 48/10; H04W 76/11

(52) U.S. Cl. CPC H04W 48/10; H04W 76/11

(57) ABSTRACT

A wireless terminal device comprising: a storage unit that holds connection ID mapping information having associated therein a connection ID and at least one logical connection destination; a communications unit that receives control information including the connection ID and communications control information for the logical connection destination; and a control unit that specifies a logical connection destination corresponding to the connection ID included in the control information received by the communications unit, on the basis of the connection ID mapping information, and performs processing on the specified logical connection destination, on the basis of the communications control information.

### TECHNICAL FIELD

The present invention relates to a radio terminal apparatus and a communication method in a next generation mobile communication system.

### BACKGROUND ART

It is expected that radio terminal apparatuses will be used for various purposes in the future and a number of radio terminal apparatuses will increase dramatically. As the number of radio terminal apparatuses increases, communication traffic at base stations will increase, and as a result communication costs will increase.

As a method of reducing the costs, a method of suppressing or shifting a peak load is known as described in NPL 1 as an example.

### CITATION LIST

### Non-Patent Literature

NPL 1

### Ji Hoon Yoon, Ross Baldick, Atila Novoselac, “Dynamic Demand Response Controller Based on Real-Tunime Retail Price for Residential Buildings,” IEEE TRANSACTIONS ON SMART GRID, VOL. 5, NO. 1, pp. 121-129, January 2014

### SUMMARY OF INVENTION

### Technical Problem

In a radio communication field, in order to reduce communication costs, suppression of the communication traffic at base stations is required.

One aspect of the present invention is to provide a radio terminal apparatus and a communication method that can suppress the communication traffic at base stations.

### Solution to Problem

A radio terminal apparatus according to one aspect of the present invention includes: a storage unit that retains connection ID mapping information associating a connection ID with at least one logical connection destination; a communicator that receives control information including a connection ID and communication control information on a logical connection destination; and a controller that identifies, on a basis of the connection ID mapping information, a logical connection destination associated with the connection ID included in the control information received by the communicator and performs processing based on the communication control information for the identified logical connection destination.

### Advantageous Effects of Invention

According to the present invention, it is possible to suppress the communication traffic at base stations.

### BRIEF DESCRIPTION OF DRAWINGS

FIG. 1 is a diagram illustrating a configuration example of a communication system according to Embodiment 1;

FIG. 2 is a diagram illustrating a configuration example of a core NW node according to Embodiment 1;

FIG. 3 is a diagram illustrating a configuration example of a terminal according to Embodiment 1;

FIG. 4 is a diagram illustrating an example of connection ID mapping information according to Embodiment 1;

FIG. 5 is a diagram illustrating an example of control information according to Embodiment 1;

FIG. 6 is a flowchart illustrating an example of control information reception processing in the terminal according to Embodiment 1;

FIG. 7 is a flowchart illustrating an example of communication control processing in the terminal according to Embodiment 1;

FIG. 8 is a diagram illustrating an example of an update information included in a SIB1 according to Embodiment 2;

FIG. 9 is a diagram illustrating an example of an update information included in a SIBn, where n is two or more, according to Embodiment 2; and

FIG. 10 is a diagram illustrating an example of a hardware configuration of the core NW node, a base station, and the terminal according to the present invention.

### DESCRIPTION OF EMBODIMENTS

Hereinafter, several embodiments for suppressing a communication traffic at base stations will be described. Suppressing the communication traffic at base stations will also lead to reduction in communication costs.

### Embodiment 1

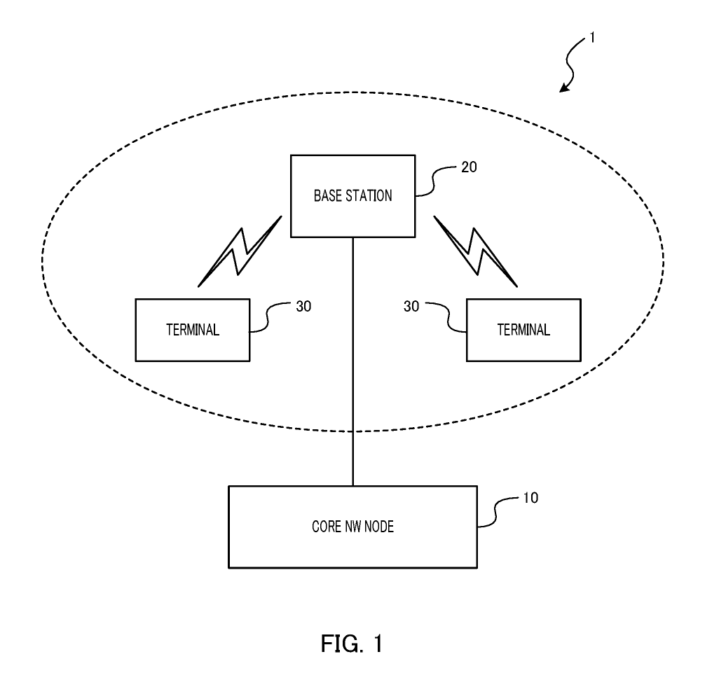

FIG. 1 is a diagram illustrating a configuration example of communication system 1 according to Embodiment 1. Communication system 1 shown in FIG. 1 includes at least core network node (core NW node) 10, base station 20 (sometimes also called eNB), and radio terminal apparatus (hereinafter referred to as “terminal”) 30. For example, core NW node 10, base station 20, and terminal 30 constitute at least part of a cellular network (for example, a 5G system and/or the like).

Core NW node 10 accommodates at least one radio access network (base station 20).

Base station 20 connects and communicates with terminal 30 situated within a communication area covered by the base station itself or core NW node 10.

Terminal 30 makes at least one logical connection with core NW node 10 via base station 20. The logical connection is, for example, a bearer connection or Packet Data Network (PDN) connection.

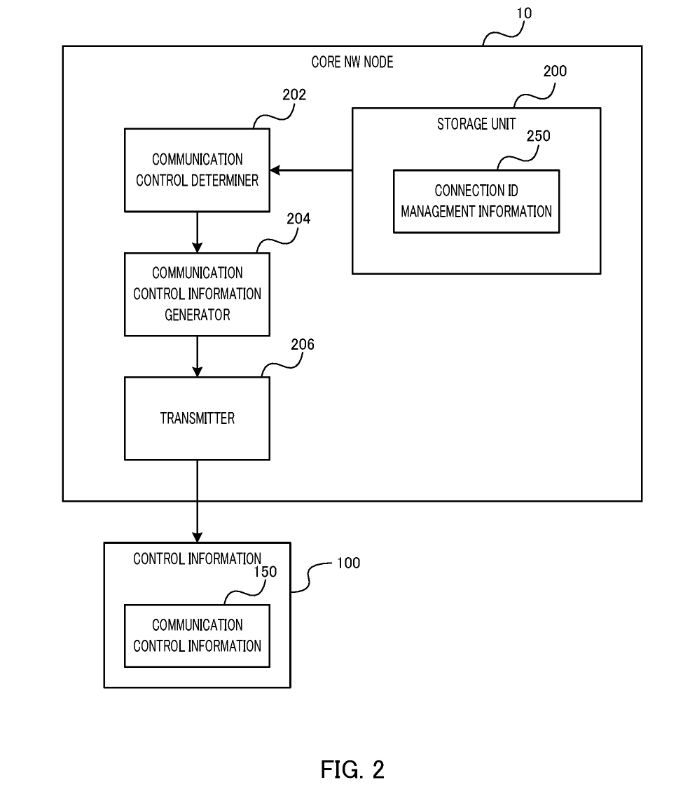

FIG. 2 is a diagram illustrating a configuration example of core NW node 10 according to Embodiment 1. Core NW node 10 shown in FIG. 2 includes storage unit 200, communication control determiner 202, communication control information generator 204, and transmitter 206.

Storage unit 200 retains connection ID management information 250 for managing a correspondence relation between a connection ID and a logical connection destination. The logical connection destination is information indicating a connection destination of logical connection. The logical connection destination is, for example, an Access Point Name (APN), a bearer, logical channel number, connection priority, or packet priority. The connection ID is an ID for identifying one or more logical connection destinations.

Communication control determiner 202 determines a connection ID to be subjected to a communication control and contents of the communication control. Communication control determiner 202 may determine those so as to reduce a peak communication traffic. Alternatively, communication control determiner 202 may determine those so as to level the communication traffic temporally and/or geographically.

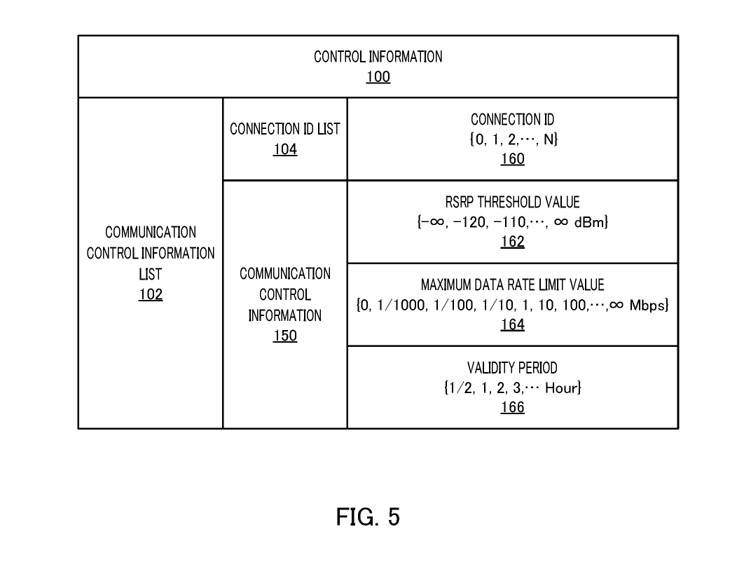

Communication control information generator 204 generates communication control information 150 including the connection ID and the contents of the communication control determined by communication control determiner 202. Details of communication control information 150 will be described later (see FIG. 5).

Transmitter 206 includes communication control information 150 generated by communication control information generator 204 in control information 100 and transmits control information 100 to terminal 30 via base station 20.

Control information 100 is information which terminal 30 can receive regardless of whether or not terminal 30 is connecting with the logical connection destination or regardless of whether a state of terminal 30 is CONNECTED or IDLE. Control information 100 is transmitted to terminal 30 via a transport channel.

In a case of a Long Term Evolution (LTE) system, control information 100 is transmitted through at least one of a broadcast channel, paging channel, and downlink shared channel. Control information 100 may be a master information block (MIB) in the broadcast channel, paging information in the paging channel, or a system information block (SIB) in the downlink shared channel.

A channel on which control information 100 is transmitted is not limited to the above. Control information 100 may be transmitted through at least one of a group-directed downlink control channel, group-directed downlink data channel, and random access channel.

In the group-directed downlink control channel, control information 100 may be downlink control information that is masked by a group Radio Network Temporary ID (RNTI) notified via broadcast information and notified in a common search space.

Alternatively, in the group-directed downlink data channel, control information 100 may be higher-layer control information (for example, a MAC control element) that is masked by the group RNTI notified via the broadcast information and notified using a downlink data channel scheduled in the common search space.

Communication control information 150 may be transmitted by a Multimedia Broadcast and Multicast Service (MBMS) or Single Cell Point-to-Multipoint (SC-PTM).

A logical connection destination corresponding to the group RNTI may be preset to terminal 30 or may be set to terminal 30 through the broadcast information or an higher-layer signaling. Alternatively, a connection ID is notified together with the group RNTI, and terminal 30 receives the notification and may retain the connection ID in association with its logical connection destination. This allows terminal 30 to recognize the RNTI to be monitored.

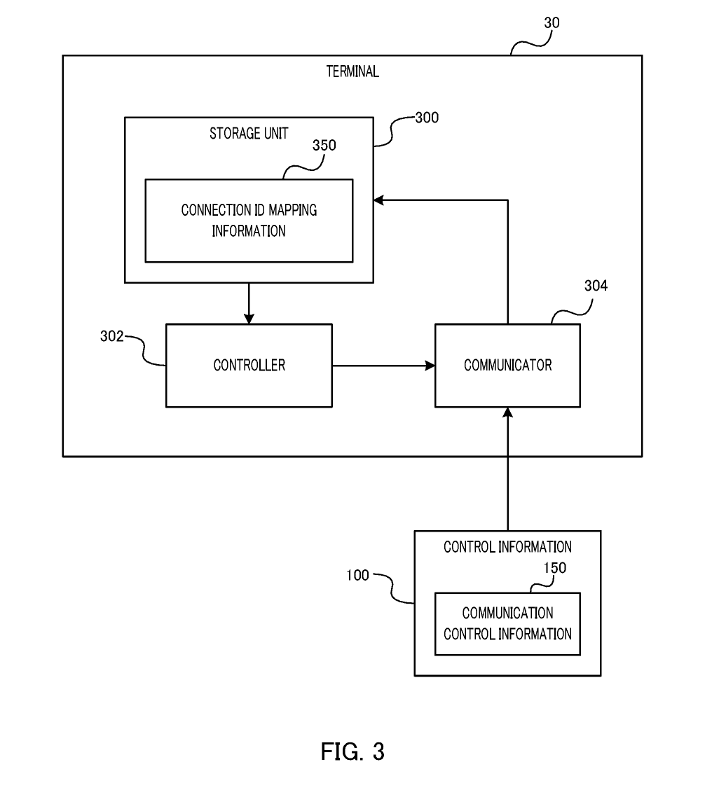

FIG. 3 is a diagram illustrating a configuration example of terminal 30 according to Embodiment 1. Terminal 30 shown in FIG. 3 includes storage unit 300, communicator 304, and controller 302.

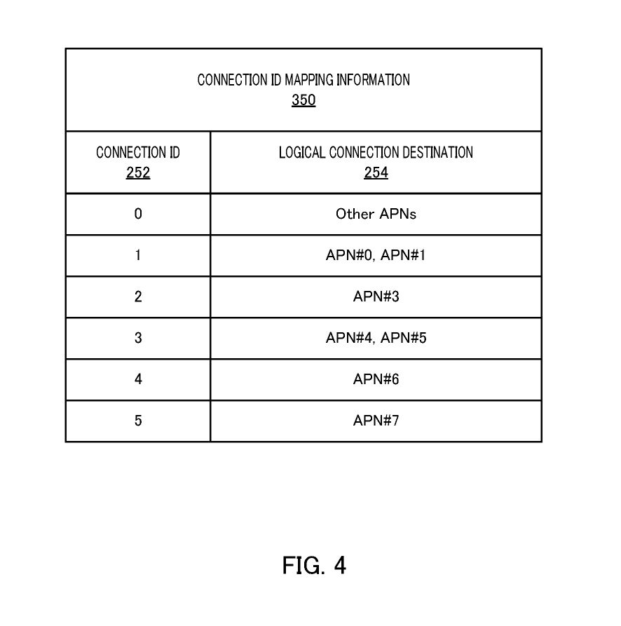

Storage unit 300 retains connection ID mapping information 350 associating a connection ID with at least one logical connection destination. Details of connection ID mapping information 350 will be described later (see FIG. 4).

Communicator 304 controls connection and communication with the logical connection destination. Communicator 304 can receive control information 100 from base station 20 regardless of whether or not terminal 30 is connecting with the logical connection destination or regardless of whether the state of terminal 30 is CONNECTED or IDLE. Communicator 304 retains communication control information 150 included in received control information 100 in storage unit 300.

Controller 302 identifies the logical connection destination associated with a connection ID included in control information 100 received by communicator 304 on the basis of connection ID mapping information 350, and performs processing based on communication control information 150 on the identified logical connection destination. Details of communication control information 150 and details of the processing based on communication control information 150 will be described later.

Next, above-described connection ID mapping information 350 will be described in detail.

FIG. 4 is a diagram illustrating an example of connection ID mapping information 350. Connection ID mapping information 350 shown in FIG. 4 is information indicating a correspondence relation between connection ID 252 and one or more logical connection destinations 254. In the embodiment, a case where logical connection destination 254 is an APN will be described.

Connection ID mapping information 350 is preset to storage unit 300 of terminal 30 by the higher-layer signaling, presetting, and/or the like.

Connection ID mapping information 350 in FIG. 4 indicates that connection ID 252 “1” is associated with logical connection destinations 254 “APN#0” and “APN#1.”

Connection ID mapping information 350 in FIG. 4 associates an APN not explicitly indicated by the connection ID with connection ID “0” (default identification ID).

Next, above-described control information 100 will be described in detail.

FIG. 5 is a diagram illustrating an example of control information 100. Control information 100 shown in FIG. 5 includes at least one communication control information list 102. Communication control information list 102 associates connection ID list 104 including at least one connection ID 160 with communication control information 150. Communication control information 150 includes information on a communication control at a logical connection destination associated with connection ID 160.

Communication control information 150 includes, for example, information on at least one communication control of following first to fourth information.

(First Information)

The first information is information for controlling (prohibiting or permitting) transmission of a request or information to logical connection destination 254 associated with connection ID 160. For example, the first information is information for permitting a radio connection (Radio Resource Control (RRC) connection and/or the like) but prohibiting establishing a particular APN or bearer.

For example, the first information is information for permitting a radio connection (RRC connection and/or the like) or logical connection but prohibiting transmitting a resource allocation request to the logical connection destination. Information of which transmission is controlled is, for example, a random access preamble, schedule request, or buffer status report.

(Second Information)

The second information is information including conditions for controlling (prohibiting or permitting) transmission of the request or information to logical connection destination 254 associated with connection ID 160.

The conditions are, for example, prohibiting transmission of a request and/or the like until a predetermined time passes after receiving communication control information 150, prohibiting transmission of the request and/or the like in a case where a radio quality is less than a threshold value (or threshold value or more), or prohibiting transmission of the request and/or the like with a predetermined probability.

The radio quality is, for example, Reference Signal Received Power (RSRP), Reference Signal Received Quality (RSRQ), or Received Signal Strength Indicator (RSSI). Alternatively, a threshold value of terminal moving speed that indirectly affects the radio quality may be one of the conditions. This also enables, for example, control such as not performing communication during high-speed movement.

In a case where prohibiting transmission of a request and/or the like with the predetermined probability is set in the conditions, terminal 30, for example, determines whether transmission is permitted or prohibited with the predetermined probability every time a predetermined period passes.

(Third Information)

The third information is information indicating a limit at logical connection destination 254 associated with connection ID 160. For example, it is information indicating a maximum data rate limit value at logical connection destination 254.

(Fourth Information)

The fourth information is information indicating a validity period of communication control information 150. For example, it is information on a relative time of the validity period, an absolute time of start and end of the validity period, or an absolute time of end of the validity period.

Communication control information 150 may include information on a cell ID and/or frequency to be restricted. This enables control by inter-cell and inter-carrier.

In Embodiment 1, an example in which communication control information 150 includes RSRP threshold value 162, maximum data rate limit value 164, and validity period 166 will be described.

RSRP threshold value 162 indicates a threshold value for RSRP. A unit of RSRP is, for example, “dBm.”

Maximum data rate limit value 164 indicates a maximum value of a data rate at a time of restriction. A unit of maximum data rate limit value 164 is, for example, “Mbps.”

Validity period 166 indicates a valid period of communication control information 150, for example, a period during which communication control relating to above-described RSRP threshold value 162 and/or maximum data rate limit value 164 is valid. In validity period 166, a valid time after receiving communication control information 150 is set, for example, 30 minutes or 1 hour is set. Alternatively, in validity period 166, a last date and time until which communication control information 150 is valid is set, for example, 11:55 on Oct. 26, 2016 is set.

In a case where core NW node 10 rejects connection from terminal 30 of which signal strength is less than a predetermined threshold value regarding the logical connection destination, core NW node 10 sets a connection ID associated with logical connection destination 254 to connection ID 160 as one of communication control information list 102, sets a predetermined threshold value to RSRP threshold value 162 of communication control information 150, and generates control information 100. Terminal 30 that has received this control information 100 determines not to transmit a connection request to logical connection destination 254 associated with connection ID 160 in a case where its signal strength is less than RSRP threshold value 162 included in communication control information 150.

In a case where core NW node 10 limits a maximum value of a data rate regarding the logical connection destination, core NW node 10 sets a connection ID associated with the logical connection destination to connection ID 160 as one of communication control information list 102, sets the maximum value of the data rate to maximum data rate limit value 164 of communication control information 150, and generates control information 100. Terminal 30 that has received this control information 100, for example, refers to maximum data rate limit value 164, and in a case where terminal 30 determines that a desired result will not be obtained even in a case where it connects with logical connection destination 254 associated with connection ID 160, terminal 30 determines not to transmit a connection request to logical connection destination 254.

In a case where core NW node 10 provides an expiration date for communication control of the logical connection destination, core NW node 10 sets a connection ID associated with the logical connection destination to connection ID 160 as one of communication control information list 102, sets a period for performing the communication control to validity period 166 of communication control information 150, and generates control information 100. Terminal 30 that has received this control information 100 determines not to transmit a connection request to the logical connection destination associated with connection ID 160 during validity period 166.

According to the above, it is possible to prevent terminal 30 from transmitting unnecessary requests to a non-connectable logical connection destination. That is, it is possible to reduce a frequency at which base station 20 receives an unnecessary signaling. It is also possible to reduce power consumption of terminal 30.

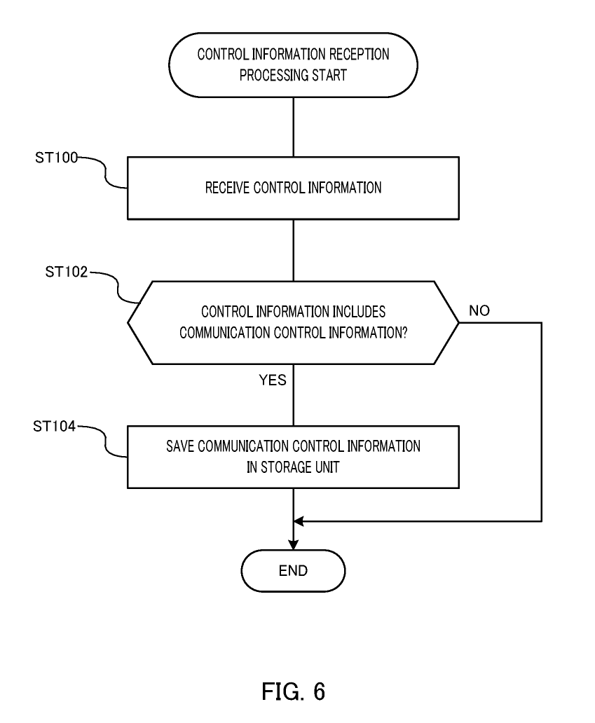

FIG. 6 is a flowchart illustrating an example of control information reception processing in terminal 30. The reception processing of control information 100 in terminal 30 will be described below with reference to FIG. 6. The flowchart explains processing related to communication control information 150, and omits explanation of processing related to other information included in control information 100.

When communicator 304 of terminal 30 receives control information 100 at ST100, communicator 304 determines whether received control information 100 includes communication control information 150 at ST102. Communicator 304 can receive control information 100 regardless of whether or not terminal 30 is connecting with the logical connection destination or regardless of whether the state of terminal 30 is CONNECTED or IDLE.

In a case where control information 100 does not include communication control information 150 (ST102: NO), communicator 304 ends the processing.

In a case where control information 100 includes communication control information 150 (ST102: YES), communicator 304 retains communication control information 150 in storage unit 300 (ST104) and ends the processing.

According to the above-described processing, terminal 30 can retain communication control information 150 included in control information 100 in storage unit 300 regardless of whether or not terminal 30 is connecting with the logical connection destination or regardless of whether the state of terminal 30 is CONNECTED or IDLE.

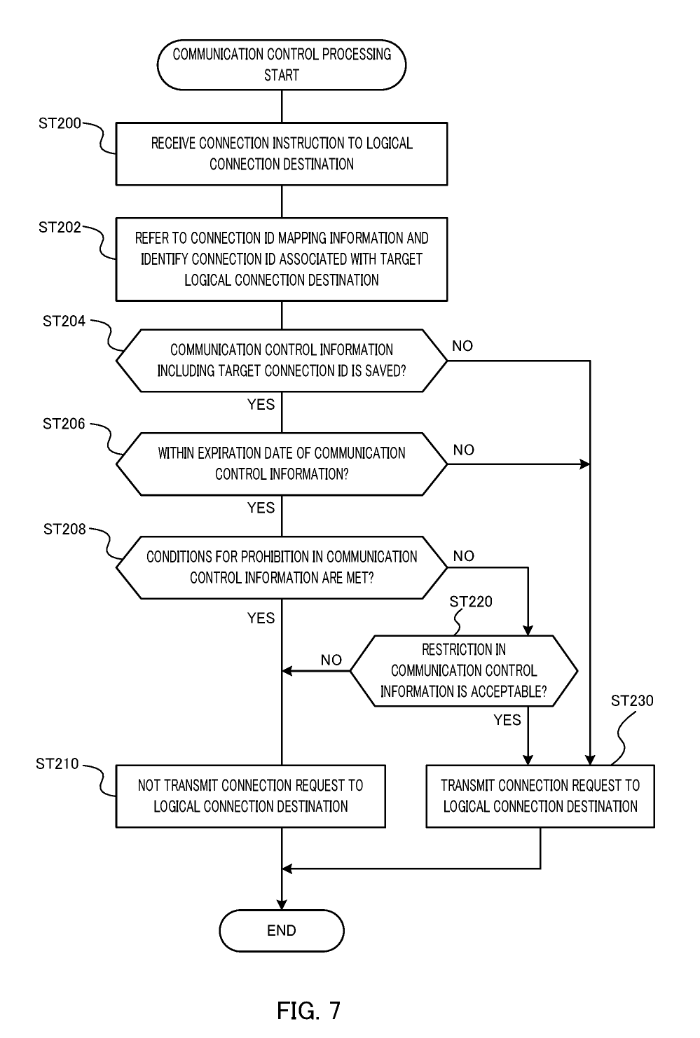

FIG. 7 is a flowchart illustrating an example of communication control processing in terminal 30. An operation of terminal 30 based on communication control information 150 will be described below with reference to FIG. 7.

When controller 302 of terminal 30 receives connection instructions from an higher layer such as an application to a logical connection destination at ST200, controller 302 refers to connection ID mapping information 350 retained in storage unit 300 and identifies connection ID 252 associated with target logical connection destination 254 at ST202. In the description of the figure, a logical connection destination instructed to connect from the higher layer is referred to as “target logical connection destination.” Also, identified connection ID 252 is referred to as “target connection ID.”

At ST204, controller 302 determines whether communication control information 150 including the target connection ID exists in storage unit 300. That is, controller 302 determines whether there is any communication control (such as prohibition of connection or transmission) about target logical connection destination 254.

In a case where communication control information 150 including the target connection ID does not exist in storage unit 300 (ST204: NO), there is not any communication control about target logical connection destination 254, so controller 302 determines to transmit a connection request to target logical connection destination 254 at ST 230. Then, controller 302 ends the processing.

In a case where communication control information 150 including the target connection ID exists in storage unit 300 (ST204: YES), controller 302 refers to validity period 166 included in communication control information 150 and determines whether communication control information 150 is valid at ST206. For example, in a case where current time is within validity period 166, controller 302 determines that it is valid. In a case where current time is out of validity period 166, controller 302 determines that it is invalid. Furthermore, in a case where current time is after validity period 166, controller 302 may delete communication control information 150 from storage unit 300.

In a case where communication control information 150 is invalid (ST206: NO), controller 302 determines to transmit a connection request to target logical connection destination 254 at ST230. Then, controller 302 ends the processing.

In a case where communication control information 150 is valid (ST206: YES), controller 302 determines whether a current state falls under prohibition conditions included in communication control information 150 at ST208. For example, in a case where current signal strength is less than RSRP threshold value 162, controller 302 determines that the current state falls under the prohibition conditions.

In a case where the current state falls under the prohibition conditions (ST208: YES), connection is rejected even in a case where a connection request to the target logical connection destination is transmitted, so at ST210 controller 302 determines not to transmit the connection request to target logical connection destination 254. Then, controller 302 ends the processing.

In a case where the current state does not fall under the prohibition conditions (ST208: NO), controller 302 determines whether restriction on target logical connection destination 254 included in communication control information 150 can be tolerated at ST220. For example, in a case where maximum data rate limit value 164 is less than a desired data rate, controller 302 determines that the restriction cannot be tolerated. The determination may be made by a higher layer (application and/or the like) of controller 302. In this case, controller 302 provides the higher layer with information on the restriction.

In a case where the restriction cannot be tolerated (ST220: NO), a desired result cannot be obtained in an operation of the higher layer even in a case where a connection to target logical connection destination 254 is made, so at ST210 controller 302 determines not to transmit the connection request to target logical connection destination 254.

In a case where the restriction can be tolerated (ST220: YES), controller 302 determines to transmit the connection request to target logical connection destination 254 through communicator 304 at ST230. Then, controller 302 ends the processing.

Terminal 30 can determine not only transmission of the connection request but also permission/rejection of transmission of other requests or reports as in the above-described processing.

### Effects of Embodiment 1

In this way, according to Embodiment 1, terminal 30 can prevent or reduce transmission of unnecessary requests and/or the like to logical connection destination 254 by referring to communication control information 150. This can reduce a frequency at which base station 20 receives a signaling from terminal 30. That is, the communication traffic at base station 20 can be reduced.

Terminal 30 can reduce power consumption by not transmitting unnecessary requests and/or the like.

### Modified Example of Embodiment 1

Core NW node 10 may give notice of communication control information 150 for each connection ID by an individual signaling of terminal 30. For example, core NW node 10 may include communication control information 150 for each connection ID in a message (random access response) from base station 20 in random access. In this case, terminal 30 needs to notify base station 20 that the message is a random access response for logical connection. Therefore, core NW node 10 notifies terminal 30 of information on a connection ID specific random access sequence or resource by using, for example, broadcast information.

Core NW node 10 may include information on RRC connection rejection in MAC control information 100 and thereby stop a random access transmission for logical connection from terminal 30. A period of transmission stop may be a predetermined period or notified by MAC control information.

Communication control information 150 for each connection ID may not affect an establishment of random access but restrict a logical connection request such as Attach transmitted after terminal 30 establishes an RRC connection.

When a communication permission is notified, a random time offset or transmission permission determination probability may be applied to the terminal so that a lot of terminals do not transmit a random access or scheduling request at the same time. A range of the time offset, a probability of the transmission permission determination, and/or the like may be notified to the terminal by broadcast and/or the like, or may be freely selected from a predetermined range by the terminal.

### Embodiment 2

In Embodiment 1, the example in which communication control information 150 is included in control information 100 and transmitted is described. In this case, there is a possibility that an update frequency of control information 100 will increase. For example, in a case where control information 100 is a System Information Block (SIB), a current LTE system only notifies terminal 30 that the SIB was updated, and terminal 30 cannot recognize which SIB was updated.

In Embodiment 2, in order to cope with an increase in the update frequency of control information 100, communication system 1 that allows terminal 30 to recognize which control information 100 is to be updated (or was updated) will be described. A case where control information 100 is the SIB will be described in Embodiment 2, but Embodiment 2 is not limited to this. Embodiment 2 is applicable to, for example, group-directed control information 100 or group-directed data transmission.

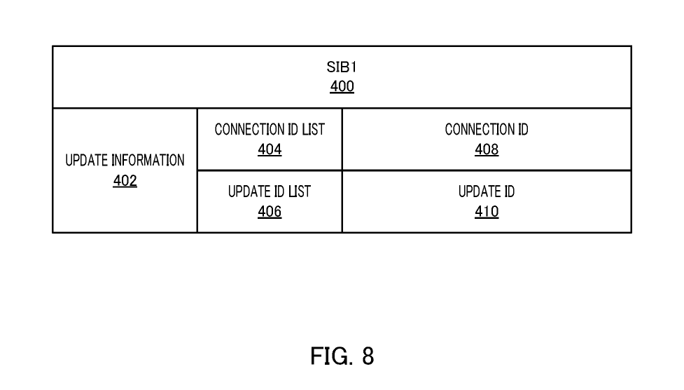

FIG. 8 illustrates an example to include update information in SIB1 400. As shown in FIG. 8, SIB1 400 includes at least one update information 402. Update information 402 of SIB1 400 associates connection ID list 404 including at least one connection ID 408 with update ID list 406 including at least one update ID 410. Update ID 410 is associated with at least one SIB number. A correspondence relation between update ID 410 and the SIB number may be preset to storage unit 300 of terminal 30, similarly to connection ID mapping information 350 described in Embodiment 1. Furthermore, in a case where the SIB1 is broadcast information monitored by all terminals 30 connected with or in an area of a carrier transmitting the SIB1, the SIB1 is not limited to this and may be other broadcast information.

Terminal 30 receives update information 402 included in SIBn 400 and thereby can recognize that a SIB with a SIB number associated with update ID 410 is to be updated (or was updated) regarding logical connection destination 254 associated with connection ID 408.

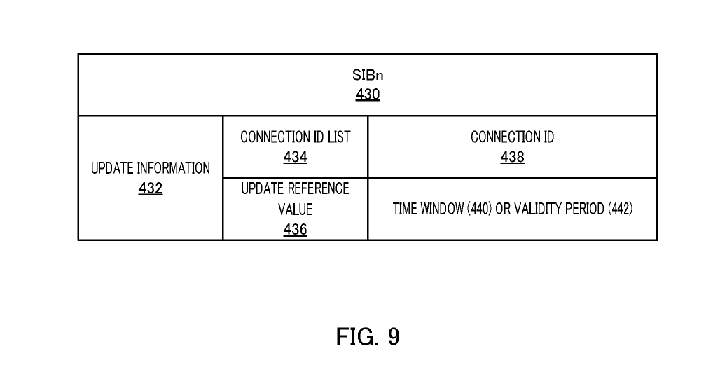

FIG. 9 illustrates an example of update information included in SIBn 430, where n is an integer of two or more. As shown in FIG. 9, SIBn 430 includes at least one update information 432. Update information 432 of SIBn 430 associates connection ID list 434 including at least one connection ID 438 with update reference value 436. Update reference value 436 includes at least one of time window 440 and validity period 442.

Time window 440 indicates a time when its SIBn 430 is next updated. Time window 440 may be defined as an absolute time. This is to prevent interpretation of time window 440 from being different depending on reception timing of SIBn 430.

Validity period 442 indicates a valid period of its SIBn 430. Validity period 442 may be defined as an absolute time. This is to prevent interpretation of validity period 442 from being different depending on reception timing of SIBn 430.

Terminal 30 receives update information 432 included in SIBn 430 and thereby can recognize when its SIBn 430 is to be updated (or was updated) regarding the logical connection destination associated with connection ID 438.

### Effects of Embodiment 2

According to Embodiment 2, terminal 30 refers to update information 402 and 432 included in control information 100 and thereby can recognize which control information 100 is to be updated (or was updated) at which timing in addition to update of control information 100. Thereby, even in a case where the update frequency of certain control information 100 increases, base station 20 does not necessarily need to notify all terminals 30 of this. Therefore, it is possible to reduce the communication traffic at base station 20.

Because terminal 30 does not need to search for control information 100 that is to be updated (was updated), terminal 30 can reduce power consumption.

### Modified Example of Embodiment 2

A service-specific paging may include information for identifying a SIB of update. Terminal 30 receives the paging and can recognize which SIB is to be updated (or was updated). In this case, for example, terminal 30 in an IDLE state calculates a reception timing of the paging using a service-specific ID (for example, a connection ID). In a case where the paging is received, or in a case where the paging is received and an update ID of the SIB indicates update, terminal 30 may determine that the SIB is to be updated (was updated). Then, terminal 30 may designate the SIB about which the terminal 30 has determined that it is to be updated (was updated). The paging may be used as a connection permission notice. In this case, terminal 30 receiving the paging may notify its higher layer that communication is permitted.

The service-specific ID may be preset to terminal 30. The setting may be done through a signaling of the higher layer.

Downlink control information 100 for notifying the service-specific paging may be masked by the service-specific ID or an RNTI calculated from the service-specific ID without being masked by a P-RNTI.

Terminal 30 calculates a reception timing of a previous paging in addition to the reception timing of the paging based on the service-specific ID, and thereby enables coexistence of the previous paging.

(Hardware Configuration)

Note that the block diagrams used to describe the embodiments illustrate blocks on the basis of functions. These functional blocks (constituent sections) are implemented by any combination of hardware and/or software. A means for realizing the functional blocks is not particularly limited. That is, the functional blocks may be implemented by one physically and/or logically coupled apparatus. Two or more physically and/or logically separated apparatuses may be directly and/or indirectly (for example, wired and/or wireless) connected, and the plurality of apparatuses may implement the functional blocks.

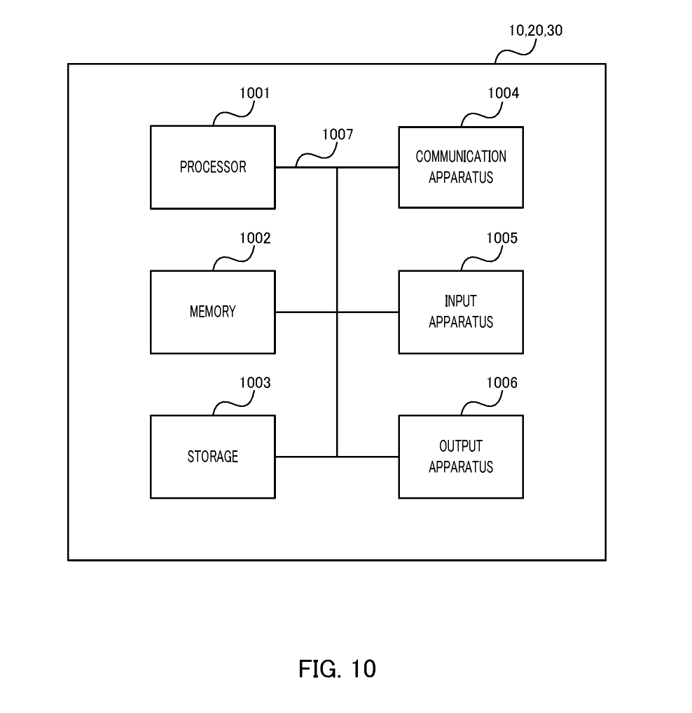

For example, core NW node 10, base station 20, and terminal 30, and/or the like, according to an embodiment of the present invention may function as computers which perform processing of the radio communication method of the present invention. FIG. 10 illustrates an example of hardware configurations of core NW node 10, base station 20, and terminal 30 according to an embodiment of the present invention. The above-described core NW node 10, base station 20, and terminal 30 may be physically configured as a computer apparatus including processor 1001, memory 1002, storage unit 1003, communication apparatus 1004, input apparatus 1005, output apparatus 1006, bus 1007, and/or the like.

Note that the term “apparatus” in the following description can be replaced with a circuit, a device, a unit, and/or the like. The hardware configurations of core NW node 10, base station 20, and terminal 30 may include one or a plurality of apparatuses illustrated in the drawings or may not include part of the apparatuses.

For example, although only one processor 1001 is illustrated, there may be a plurality of processors. The processing may be executed by one processor, or the processing may be executed by one or more processors at the same time, in succession, or in another manner. Note that processor 1001 may be implemented by one or more chips.

The functions in core NW node 10, base station 20, and terminal 30 are implemented by predetermined software (program) loaded into hardware, such as processor 1001, memory 1002, and/or the like, according to which processor 1001 performs the arithmetic and controls communication performed by communication apparatus 1004 or reading and/or writing of data in memory 1002 and storage unit 1003.

Processor 1001 operates an operating system to entirely control the computer, for example. Processor 1001 may be composed of a central processing unit (CPU) including an interface with peripheral apparatuses, control apparatus, arithmetic apparatus, register, and/or the like. For example, processor 1001 may implement the above-described sections including communication control determiner 202, communication control information generator 204, and controller 302.

Processor 1001 reads out a program (program code), a software module, or data from storage unit 1003 and/or communication apparatus 1004 to memory 1002 and executes various types of processing according to the read-out program and/or the like. The program used is a program for causing the computer to execute at least part of the operation described in the embodiments. For example, controller 302 of terminal 30 may be implemented by a control program stored in memory 1002 and operated by processor 1001, and the other functional blocks may also be implemented in the same way. While it has been described that the various types of processing as described above are executed by one processor 1001, the various types of processing may be executed by two or more processors 1001 at the same time or in succession. Processor 1001 may be implemented by one or more chips. Note that the program may be transmitted from a network through a telecommunication line.

Memory 1002 is a computer-readable recording medium and may be composed of, for example, at least one of a ROM (Read Only Memory), an EPROM (Erasable Programmable ROM), an EEPROM (Electrically Erasable Programmable ROM), and a RAM (Random Access Memory). Memory 1002 may be called a register, a cache, a main memory (main storage apparatus), and/or the like. Memory 1002 can save a program (program code), a software module, and/or the like that can be executed to carry out the radio communication method according to an embodiment of the present invention.

Storage unit 1003 is a computer-readable recording medium and may be composed of, for example, at least one of an optical disk such as a CD-ROM (Compact Disc ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage unit 1003 may also be called an auxiliary storage apparatus. The storage medium as described above may be a database, server, or other appropriate media including memory 1002 and/or storage unit 1003. For example, memory 1002 and/or storage unit 1003 may implement above-described storage units 200 and 300 and/or the like.

Communication apparatus 1004 is hardware (transmission and reception device) for communication between computers through a wired and/or wireless network and is also called, for example, a network device, a network controller, a network card, or a communication module. For example, communication apparatus 1004 may implement above-described transmitter 206, communicator 304, and/or the like.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which outputs to the outside. Note that input apparatus 1005 and output apparatus 1006 may be integrated (for example, a touch panel).

The apparatuses, such as processor 1001 and memory 1002, are connected by bus 1007 for communication of information. Bus 1007 may be composed of a single bus or by buses different among the apparatuses.

Furthermore, core NW node 10, base station 20, and terminal 30 may include hardware, such as a microprocessor, a digital signal processor (DSP), an ASIC (Application Specific Integrated Circuit), a PLD (Programmable Logic Device), and an FPGA (Field Programmable Gate Array), and the hardware may implement part or all of the functional blocks. For example, processor 1001 may be implemented by at least one of these pieces of hardware.

(Modifications of Present Invention)

Note that the terms described in the present specification and/or the terms necessary to understand the present specification may be replaced with terms with the same or similar meaning. For example, the channel and/or the symbol may be a signal. The signal may be a message. The component carrier (CC) may be called a carrier frequency, a cell, and/or the like. The reference signal can also be abbreviated as RS and may also be called a pilot depending on the applied standard. The demodulation RS and the correction RS may be called by other corresponding names, respectively. The demodulation RS and the correction RS may be specified by the same name (for example, demodulation RS).

The DL data signal may be referred to as a physical downlink shared channel (PDSCH) or downlink data channel. In addition, the DL control signal may be referred to as a physical downlink control channel (PDCCH) or downlink control channel.

The radio frame may be constituted by one frame or a plurality of frames in the time domain. The one frame or each of the plurality of frames may be called a subframe, a time unit, and/or the like in the time domain. The subframe may be further constituted by one slot or a plurality of slots in the time domain. A slot may be further composed of one or more symbols (Orthogonal Frequency Division Multiplexing (OFDM) symbols, Single Carrier-Frequency Division Multiple Access (SC-FDMA) symbols, and/or the like) in the time domain.

All of a radio frame, sub-frame, slot, and symbol represent a time unit when a signal is transmitted. The radio frame, sub-frame, slot, and symbol may be a different name corresponding to each of them.

For example, in the LTE system, the base station creates a schedule for assigning radio resources to each mobile station (such as frequency bandwidth that can be used by each mobile station and transmission power). The minimum time unit of scheduling may be called a TTI (Transmission Time Interval).

For example, one sub-frame may be referred to as TTI, a plurality of consecutive sub-frames may be referred to as TTI, and one slot may be referred to as TTI.

The resource unit is a resource assignment unit in the time domain and the frequency domain, and the resource unit may include one subcarrier or a plurality of continuous subcarriers in the frequency domain. In addition, the time domain of a resource unit may include one or more symbols and may be length of one slot, one sub-frame, or one TTI. One TTI and one subframe may be constituted by one resource unit or a plurality of resource units. The resource unit may be called a resource block (RB), a physical resource block (PRB: Physical RB), a PRB pair, an RB pair, a scheduling unit, a frequency unit, or a subband. The resource unit may be constituted by one RE or a plurality of REs. For example, one RE only has to be a resource smaller in unit size than the resource unit serving as a resource assignment unit (for example, one RE only has to be a minimum unit of resource), and the naming is not limited to RE.

The above-described structure of the radio frame is merely an example, and a number of sub-frames included in the radio frame, a number of slots included in the sub-frame, and numbers of symbols and resource blocks included in the slot, and a number of subcarriers included in the resource block can be variously changed.

The notification of information is not limited to the aspects or embodiments described in the present specification, and the information may be notified by another method. For example, the notification of information may be carried out by one or a combination of physical layer signaling (for example, DCI (Downlink Control Information) and UCI (Uplink Control Information)), higher layer signaling (for example, RRC (Radio Resource Control) signaling, MAC (Medium Access Control) signaling, broadcast information (MIB (Master Information Block), and SIB (System Information Block))), and other signals. The RRC signaling may be called an RRC message and may be, for example, an RRC connection setup message, an RRC connection reconfiguration message, and/or the like.

The aspects and embodiments described in the present specification may be applied to a system using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), or other appropriate systems and/or to a next-generation system extended based on the above systems.

The base station (radio base station) can accommodate one cell or a plurality of (for example, three) cells (also called sector). When the base station accommodates a plurality of cells, the entire coverage area of the base station can be divided into a plurality of smaller areas, and each of the smaller areas can provide a communication service based on a base station subsystem (for example, small base station for indoor, remote radio head (RRH)). The term “cell” or “sector” denotes part or all of the coverage area of the base station and/or of the base station subsystem that perform the communication service in the coverage. Furthermore, the terms “base station,” “eNB,” “cell,” and “sector” can be interchangeably used in the present specification. The base station may be called a fixed station, a NodeB, an eNodeB (eNB), an access point, a femto cell, a small cell, and/or the like.

The terminal may be referred to, by those skilled in the art, as a mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, User Equipment (UE), or some other suitable terms.

The radio base station in the specification may be replaced with a user terminal. For example, each aspect/embodiment of the present invention may be applied to a configuration replacing communication between the radio base station and user terminal with communication between a plurality user terminals (D2D: Device-to-Device). In this case, terminal 30 may have the above-described functions of radio base station 20. In addition, words such as “uplink” and “downlink” may be replaced with “side.” For example, an uplink channel may be replaced with a side channel.

In the same manner, terminal 30 in the specification may be replaced with a radio base station. In this case, radio base station 20 may have the above-described functions of terminal 30.

Specific operations which are described in the specification as being performed by the base station (radio base station) may sometimes be performed by a higher node depending on the situation. Various operations performed for communication with a terminal in a network constituted by one network node or a plurality of network nodes including a base station can be obviously performed by the base station and/or a network node other than the base station (examples include, but not limited to, MME (Mobility Management Entity) or S-GW (Serving Gateway)). Although there is one network node in addition to the base station in the case illustrated above, a plurality of other network nodes may be combined (for example, MME and S-GW).

The information, the signals, and/or the like can be output from a higher layer (or a lower layer) to a lower layer (or a higher layer). The information, the signals, and/or the like may be input and output through a plurality of network nodes.

The input and output information and/or the like may be saved in a specific place (for example, memory) or may be managed by a management table. The input and output information and/or the like can be overwritten, updated, or additionally written. The output information and/or the like may be deleted. The input information and/or the like may be transmitted to another apparatus.

The determination may be made based on a value expressed by one bit (0 or 1), based on a Boolean value (true or false), or based on comparison with a numerical value (for example, comparison with a predetermined value).

Terms “determining” used herein may encompass a wide variety of operations. The “determining” may include, for example, deeming judging, calculating, computing, processing, deriving, investigating, looking up (for example, looking up in tables, databases, or other data structures), and ascertaining to be “determining.” Also, the “determining” may include, for example, deeming receiving (for example, receiving information), transmitting (for example, transmitting information), input, output, accessing (for example, accessing data in a memory) to be “determining.” Furthermore, the “determining” may include deeming resolving, selecting, choosing, establishing, comparing, and/or the like to be “determining.” That is, “determining” may be regarded as a certain type of action related to determining.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. When the terms are used in the present specification, two elements can be considered to be “connected” or “coupled” to each other by using one or more electrical wires, cables, and/or printed electrical connections or by using electromagnetic energy, such as electromagnetic energy with a wavelength of a radio frequency domain, a microwave domain, or an optical (both visible and invisible) domain that are non-limiting and non-inclusive examples.

As long as “including,” “comprising,” and variations thereof are used in the specification or appended claims, these terms are intended to be inclusive in a manner similar to a term “containing.” Furthermore, it is intended that a term “or” used in the specification or appended claims is not exclusive disjunction.

The description “based on” used in the present specification does not mean “based only on,” unless otherwise specifically stated. In other words, the description “based on” means both of “based only on” and “based at least on.”

The “section” in the configuration of each apparatus may be replaced with “means,” “circuit,” “device,” and/or the like.

In the whole of the present disclosure, in a case where articles are added by translation like, for example, “a,” “an,” and “the” in English, the articles shall include plural ones unless it is indicated that these articles are obviously not so from a context.

Regardless of whether the software is called software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and/or the like.

The software, the instruction, and/or the like may be transmitted and received through a transmission medium. For example, when the software is transmitted from a website, a server, or another remote source by using a wired technique, such as a coaxial cable, an optical fiber cable, a twisted pair, and a digital subscriber line (DSL), and/or a wireless technique, such as an infrared ray, a radio wave, and a microwave, the wired technique and/or the wireless technique is included in the definition of the transmission medium.

The information, the signals, and/or the like described in the present specification may be expressed by using any of various different techniques. For example, data, instructions, commands, information, signals, bits, symbols, chips, and/or the like that may be mentioned throughout the entire description may be expressed by one or an arbitrary combination of voltage, current, electromagnetic waves, magnetic fields, magnetic particles, optical fields, and photons.

The terms “system” and “network” used in the present specification can be interchangeably used.

The information, the parameters, and/or the like described in the present specification may be expressed by absolute values, by values relative to predetermined values, or by other corresponding information. For example, radio resources may be indicated by indices.

The names used for the parameters are not limited in any respect. Furthermore, the numerical formulas and/or the like using the parameters may be different from the ones explicitly disclosed in the present specification. Various channels (for example, PUCCH and PDCCH) and information elements (for example, TPC) can be identified by any suitable names, and various names assigned to these various channels and information elements are not limited in any respect.

The orders of the processing procedures, the sequences, the flow charts, and/or the like of the aspects and embodiments described in the present specification may be changed as long as there is no contradiction. For example, elements of various steps are presented in exemplary orders in the methods described in the present specification, and the methods are not limited to the presented specific orders.

The aspects and embodiments described in the present specification may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present invention has been described in detail, it is obvious to those skilled in the art that the present invention is not limited to the embodiments described in the present specification. Modifications and variations of the aspects of the present invention can be made without departing from the spirit and the scope of the present invention defined by the description of the appended claims. Therefore, the description of the present specification is intended for exemplary description and does not limit the present invention in any sense.

The present patent application claims the benefit of priority based on Japanese Patent Application No. 2016-214692 filed on Nov. 1, 2016, and the entire content of Japanese Patent Application No. 2016-214692 is hereby incorporated by reference.

### INDUSTRIAL APPLICABILITY

An aspect of the present invention is useful for a mobile communication system.

### REFERENCE SIGNS LIST

1 Communication system
10 Core NW node
20 Base station
30 Terminal
100 Control information
150 Communication control information
200 Storage unit
202 Communication control determiner
204 Communication control information generator
206 Transmitter
300 Storage unit
302 Controller
304 Communicator
350 Connection ID mapping information
402 Update information
432 Update information

1. A radio terminal apparatus, comprising:
a storage unit that retains connection ID mapping information associating a connection ID with at least one logical connection destination;
a communicator that receives control information including a connection ID and communication control information on a logical connection destination; and
a controller that identifies, on a basis of the connection ID mapping information, a logical connection destination associated with the connection ID included in the control information received by the communicator and performs processing based on the communication control information for the identified logical connection destination.

2. The radio terminal apparatus according to claim 1, wherein:
the communication control information includes first information for prohibiting a request to a logical connection destination, and
the controller determines not to transmit a request to the identified logical connection destination in a case where a request to the logical connection destination is prohibited in the first information.

3. The radio terminal apparatus according to claim 1, wherein:
the communication control information includes second information on conditions for prohibiting a request to a logical connection destination, and
the controller determines not to transmit a request to the identified logical connection destination in a case where the conditions for prohibiting the request in the second information are met.

4. The radio terminal apparatus according to claim 1, wherein:
the communication control information includes third information on a restriction on a logical connection destination, and
the controller determines not to transmit a request to the identified logical connection destination in a case where it is determined that the restriction in the third information is not acceptable.

5. The radio terminal apparatus according claim 1, wherein:
the communication control information includes information indicating an expiration date of the communication control information, and
the controller determines to transmit a request to the identified logical connection destination regardless of other information of the communication control information in a case where it is determined that the communication control information is invalid on a basis of the expiration date of the communication control information.

6. A communication method, comprising:
receiving control information including a connection ID and communication control information on a logical connection destination; and
identifying a logical connection destination associated with the connection ID included in the received control information on a basis of connection ID mapping information associating a connection ID with at least one logical connection destination, and performing processing based on the communication control information for the identified logical connection destination.

7. The radio terminal apparatus according to claim 2, wherein:
the communication control information includes information indicating an expiration date of the communication control information, and
the controller determines to transmit a request to the identified logical connection destination regardless of other information of the communication control information in a case where it is determined that the communication control information is invalid on a basis of the expiration date of the communication control information.

8. The radio terminal apparatus according to claim 3, wherein:
the communication control information includes information indicating an expiration date of the communication control information, and
the controller determines to transmit a request to the identified logical connection destination regardless of other information of the communication control information in a case where it is determined that the communication control information is invalid on a basis of the expiration date of the communication control information.

9. The radio terminal apparatus according to claim 4, wherein:
the communication control information includes information indicating an expiration date of the communication control information, and
the controller determines to transmit a request to the identified logical connection destination regardless of other information of the communication control information in a case where it is determined that the communication control information is invalid on a basis of the expiration date of the communication control information.
